(19) United States
(12) Patent Application Publication
(10) Pub. No.: US 2023/0021338 A1
(43) Pub. Date: Jan. 26, 2023

(54) CONDITIONALLY INDEPENDENT DATA GENERATION FOR TRAINING MACHINE LEARNING SYSTEMS

(71) Applicant: International Business Machines Corporation, Armonk, NY (US)

(72) Inventors: Kartik Ahuja, White Plains, NY (US); Prasanna Sattigeri, Acton, MA (US); Karthikeyan Shanmugam, Elmsford, NY (US); Dennis Wei, Sunnyvale, CA (US); Murat Kocaoglu, West Lafayette, IN (US); Karthikeyan Natesan Ramamurthy, Pleasantville, NY (US)

(21) Appl. No.: 17/368,925

(22) Filed: Jul. 7, 2021

(51) Int. Cl. G06N 3/08; G06N 3/04

(52) U.S. Cl. CPC G06N 3/08; G06N 3/0454

(57) ABSTRACT

A method for training a machine learning system using conditionally independent training data includes receiving an input dataset (p(x, y, z)). A generative adversarial network, that includes a generator and a first discriminator, uses the input dataset to generate a training data (pₛ (x_{f}, y_{f}, z_{f})) by generating the values (x_{f}, y_{f}, z_{f}). The first discriminator determines a first loss (L₁) based on (x_{f}, y_{f}, z_{f}) and (x, y, z). A divergence calculator modifies the training data based on a dependence measure (γ). The divergence calculator includes a second discriminator and a third discriminator. Modifying the training data includes receiving a reference value (\tilde{y}), and computing, by the second discriminator, a second loss (L₂) based on (x_{f}, y_{f}, z_{f}) and (x_{f}, \tilde{y}, z_{f}). The third discriminator computes a third loss (L₃) based on (y_{f}, z_{f}) and (\tilde{y}, z_{f}). Further, a fourth loss (L₄) is computed based on L₂ and L₃. The training data is output from the generator if L₁ and L₄ satisfy a predetermined condition.

### BACKGROUND

The present invention relates in general to computing technology and relates more particularly to computing technology configured and arranged to interface with machine learning systems to provide conditionally independent generated data for training such machine learning systems.

Conditional independence (CI) has wide applications in machine learning and causal inference. In causal inference, CI tests are used to efficiently narrow down the space of causal qraphs compatible with the given data, not only in observational but also in interventional settings where data from experiments are available. In machine learning, CI tests are used as a non-parametric method for feature selection.

Due to its widespread uses, the problems of testing CI of a given data and estimating divergences have been extensively studied. The complementary problem of generating data that satisfies CI has received much less attention.

### SUMMARY

According to one or more embodiments of the present invention, a computer-implemented method for training a machine learning system using conditionally independent training data, includes receiving an input dataset (p(x, y, z)). The method further includes generating, using a generative adversarial network, based on the input dataset, a training data (pₛ (x_{f}, y_{f}, z_{f})), the generative adversarial network includes a generator and a first discriminator. Generating the training data includes generating, by the generator, the values (x_{f}, y_{f}, z_{f}) for the training data using machine learning. Generating the training data further includes determining, by the first discriminator, a first loss (L₁) based on a comparison between the values for the training data (x_{f}, y_{f}, z_{f}) and values from the input dataset (x, y, z). Further, the method includes modifying, using a divergence calculator, the training data based on a dependence measure (γ), the divergence calculator includes a second discriminator, and a third discriminator. Modifying the training data includes receiving, from a sampler, a reference value (\tilde{y}). Modifying the training data further includes computing, by the second discriminator, a second loss (L₂) based on a comparison of a first set of values (x_{f}, y_{f}, z_{f}) from the generator and a second set of values (x_{f}, \tilde{y}, z_{f}) including a combination of the training data from the generator and the reference value. Modifying the training data further includes computing, by the third discriminator, a third loss (L₃) based on a comparison of (y_{f}, z_{f}) and (\tilde{y}, z_{f}), wherein \tilde{y} is a reference value. Further, a fourth loss (L₄) is computed based on the second loss and the third loss. The method further includes outputting the training data from the generator in response to the first loss and the fourth loss satisfying a predetermined condition, the training data being conditionally independent, the training data being used to train a machine learning system.

According to one or more embodiments of the present invention, a computer system for training a machine learning system using conditionally independent training data includes a machine learning system, and a conditionally independent data generator that is configured to generate training data to train the machine learning system. The conditionally independent data generator includes a generative adversarial network that includes a generator neural network that generates a training data (pₛ (x_{f}, y_{f}, z_{f})) based on an input dataset (p(x, y, z)), and a first discriminator neural network that computes a first loss (L₁) based on a comparison between the values for the training data (x_{f}, y_{f}, z_{f}) and values from the input dataset (x, y, z). The system further includes a divergence calculator that includes a second discriminator neural network that computes a second loss (L₂) based on a comparison of a first set of values (x_{f}, y_{f}, z_{f}) from the generator and a second set of values (x_{f}, \tilde{y}, z_{f}) including a combination of the training data from the generator and a reference value (\tilde{y}). The divergence calculator also includes a third discriminator neural network that computes a third loss (L₃) based on a comparison of (y_{f}, z_{f}) and (\tilde{y}, z_{f}). The divergence calculator computes a fourth loss (L₄) based on the second loss and the third loss. The training data from the generator is output as conditionally independent training data to be used as the training data for the machine learning system in response to the first loss and the fourth loss satisfying a predetermined condition.

According to one or more embodiments of the present invention, a computer program product includes a memory device having computer-executable instructions stored thereon, the computer-executable instructions when executed by one or more processing units cause the one or more processing units to perform a method for training a machine learning system using conditionally independent training data. The method includes receiving an input dataset (p(x, y, z)). The method further includes generating, using a generative adversarial network, based on the input dataset, a training data (pₛ (x_{f}, y_{f}, z_{f})), the generative adversarial network includes a generator and a first discriminator. Generating the training data includes generating, by the generator, the values (x_{f}, y_{f}, z_{f}) for the training data using machine learning. Generating the training data further includes determining, by the first discriminator, a first loss (L₁) based on a comparison between the values for the training data (x_{f}, y_{f}, z_{f}) and values from the input dataset (x, y, z). Further, the method includes modifying, using a divergence calculator, the training data based on a dependence measure (γ), the divergence calculator includes a second discriminator, and a third discriminator. Modifying the training data includes receiving, from a sampler, a reference value (\tilde{y}). Modifying the training data further includes computing, by the second discriminator, a second loss (L₂) based on a comparison of a first set of values (x_{f}, y_{f}, z_{f}) from the generator and a second set of values (x_{f}, \tilde{y}, z_{f}) including a combination of the training data from the generator and the reference value. Modifying the training data further includes computing, by the third discriminator, a third loss (L₃) based on a comparison of (y_{f}, z_{f}) and (\tilde{y}, z_{f}), wherein \tilde{y} is a reference value. Further, a fourth loss (L₄) is computed based on the second loss and the third loss. The method further includes outputting the training data from the generator in response to the first loss and the fourth loss satisfying a predetermined condition, the training data being conditionally independent, the training data being used to train a machine learning system.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for generating conditionally independent training data for a machine learning system according to one or more embodiments of the present invention;

FIG. 2 depicts a flowchart of a method for training the neural networks of the system for generating training data conditional independence and fairness according to one or more embodiments of the present invention;

FIG. 3 depicts an architecture of a conditionally independent data generator to promote conditional statistical parity and equalized odds according to one or more embodiments of the present invention;

FIG. 4 depicts a cloud computing environment according to one or more embodiments of the present invention;

FIG. 5 depicts abstraction model layers according to one or more embodiments of the present invention; and

FIG. 6 depicts a digital computer in accordance with an embodiment.

The diagrams depicted herein are illustrative. There can be many variations to the diagram, or the operations described therein without departing from the spirit of the invention. For instance, the actions can be performed in a differing order, or actions can be added, deleted, or modified. Also, the term “coupled”, and variations thereof describe having a communications path between two elements and do not imply a direct connection between the elements with no intervening elements/connections between them. All of these variations are considered a part of the specification.

### DETAILED DESCRIPTION

Exemplary embodiments of the present invention relate to, among other things, devices, systems, methods, computer-readable media, techniques, and methodologies for generating data with a desired conditional independence (CI). In some embodiments, generating conditionally independent data manifests as modifying a given dataset for which the CI is not satisfied.

Machine learning systems, such as those using deep learning algorithms, require large amounts (e.g., thousands, millions, billions, or even more data samples) of labeled (annotated) data to train effective models for the performance of cognitive operations, such as image classification or the like. However, such large amounts of data are not readily available, limiting the training of such machine learning systems. For example, in the case of medical imaging, the abundance of data can be restricted because of privacy laws, health industry standards, the lack of integration of medical information systems, and other considerations. Such lack of data is a technical challenge that hampers the speed of innovation of deep learning algorithms, and in turn, computing technology and its application to various technical fields.

Further, in some cases, even if a large amount of data is available, the data is unstructured and lacks proper labeling or annotations, e.g., labeling anatomical structures within the medical image, measurements, abnormalities, or the like. To address the technical challenges described herein, the data has to be annotated. However, annotation of data, such as medical images, is an expensive, time-consuming, and largely manual process. Often, one can only feasibly label (annotated) a small portion of the available unstructured data while having a much larger portion of unlabeled data. As a result, the operations of the machine learning systems, such as medical imaging and computer vision cognitive operations, are limited to being able to use only small amounts (e.g., tens, hundreds) of labeled data, for use in training the classifier models, such as convolutional neural networks, of cognitive logic for performing cognitive classification operations, e.g., medical image classification tasks that identify diseases or abnormalities in the medical images.

Previously, the approach used to solve the problem of labeled (annotated) dataset scarcity was to use the available labeled dataset samples from a normal class to train another machine learning model, e.g., a neural network or other models for segmenting the data into separate segmented parts (e.g., sets of pixels in case of image data) that are computationally easier to analyze and/or are potentially more meaningful to the classification operation. The features produced by this segmentation model are used along with the whole data to train the classifier model. This is a way of learning the distribution of data in one class and taking advantage of the learning in distinguishing that class from other classes. This concept of “learning normal” as a way to improve abnormality classification has also been used in generative machine learning models.

Generative machine learning models have the potential to generate new dataset samples. The two main approaches of deep generative models involve either learning the underlying data distribution or learning a function to transform a sample from an existing distribution to the data distribution of interest. In deep learning, the approach of learning the underlying distribution has had considerable success with the advent of variational auto-encoders (VAEs). VAEs attempt to find the variational lower bound of the probability density function with a loss function that consists of a reconstruction error and regularizer. However, in this formulation, the bias introduced causes a reduction in the quality of the generated training data.

Generative adversarial networks (GANs) utilize two neural networks referred to as a discriminator and a generator, respectively, which operate in a minimax game to find the Nash equilibrium of these two neural networks. In short, the generator seeks to create as many realistic datasets as possible, and the discriminator seeks to distinguish between the datasets that are real and generated (fake) datasets.

Existing GANs, thus, facilitate producing a new distribution p=(X_{f}, Y_{f}), given training data from distribution pₛ=(X, Y), such that pₛ is close (within a predetermined divergence) to p. However, existing techniques cannot produce/generate training data that is close in distribution to the original data but is debiased when bias is captured by a conditional dependency.

Further, to facilitate “fair classification” the data generated has to satisfy: Y_{f}=f (X, N) where N is independent sampling noise. If the function ƒ does not impose fairness, a separate constraint is used to impose fairness. For the data generator to be a fair predictor, it has to satisfy various constraints. First, equalized odds (EO) requires CI between a protected attribute S ⊆X and predicted outcome Ŷ given the true outcome Y. Further, conditional statistical parity (CSP), which is a generalization of statistical parity, requires CI of S and Y conditioned on a set of admissible variables A that are considered legitimate factors accounting for dependence between S and Y.

The canonical problem of interest is as follows: Given samples of (x, y, z, w) drawn from pₛ(x, y, z, w), how can samples be generated from a distribution p (x_{f}, y_{f}, z_{f}, w_{f}) such that: (1) X_{f} [symbol] Y_{f}|Z_{f} and (2) pₛ and p are close in an appropriate distance measure? Here, w are variables that do not participate in determining the CI, but are used for reducing the distance between pₛ and p. This is because w could have information about, e.g., y that is not captured by other variables.

The technical solutions described herein address the above technical challenges. To address the first condition above, an approximate version of the conditional independence is sought such that p(y_{f}|x_{f}, z_{f}) is close (within predetermined distance) from p(y_{f}|z_{f}) in terms of a distance/divergence measure. The technical solution to generate data to satisfy this condition is non-trivial because the CI constraint is only on a subset of variables (x, y, z) while p and pₛ are to be matched across all variables (x, y, z, w).

Existing techniques to enforce CI typically involve obtaining samples from a “perfect” conditional sampler for pₛ(y|z), for example, using a pre-trained conditional generator. Having a perfect conditional sampler is a roadblock in implementing such techniques, particularly when z is high-dimensional.

Technical solutions described herein address the technical challenges with generating conditionally independent data based on the characterization of CI in terms of equality between two divergences that involve samples from pₛ, p, and an “imperfect” (i.e., practical) sampler qᵣ(y|z)≠pₛ(y|z). For bounded variables y, the only requirement is that qᵣ(y|z) has support overlap with pₛ(y|z). This can be ensured by a sampler on the bounded domain. Further, the technical solutions described herein facilitate identifying at least two key properties of the divergences, separability, and strict convexity, which allow this result to be proven for a large class of divergences, including Jensen-Shannon divergence, f-divergence, and Bregman divergences, among others.

Some embodiments of the present invention use a pre-trained perfect conditional generative model (or a sampler along with a trained classifier if y is categorical) to sample y from pₛ(y|z). In some embodiments of the present invention for enforcing CI is to try to obtain y_{f} as samples from pₛ(y|z) using the perfect sampler and substitute this for y to obtain p. This ensures CI in the subset x_{f}, y_{f}, z_{f}, w_{f}, after marginalizing over w. However, this is sub-optimal in terms of distance between p and pₛ because w could capture information about y that is not captured by other variables. In other embodiments, a reference distribution pᵣ(x, y, z) is constructed such that pᵣ is a conditionally independent version of pₛ over x, y, z, i.e., pᵣ (x, y, z)=pₛ (x, z) pₛ (y|z), and then p and pᵣ are contrasted using another discriminator to compute a distance between p and pᵣ. However, as noted earlier, a technical challenge is that training a perfect conditional generator is difficult when Z is high dimensional and continuous.

Technical solutions described herein address such technical challenges by enforcing CI only using access to an imperfect reference sampler qᵣ(y|z)≠pₛ(y|z). For bounded variables y, only the support of qᵣ(y|z) overlaps with pₛ(y|z), and this can be ensured by a sampler on the bounded domain. The sampler can be a uniform sampled in some embodiments. Alternatively, or in addition, the sampler is a random sampler on the same domain as that of y. The reference value, in this case, is a random sample from a sampler (more like a random number generated outside the training dataset) from the same support set/domain as that of variable y. Technical solutions described herein, accordingly, facilitate a neural network architecture system to generate conditionally independent data, satisfying a CI statement in a differentiable manner.

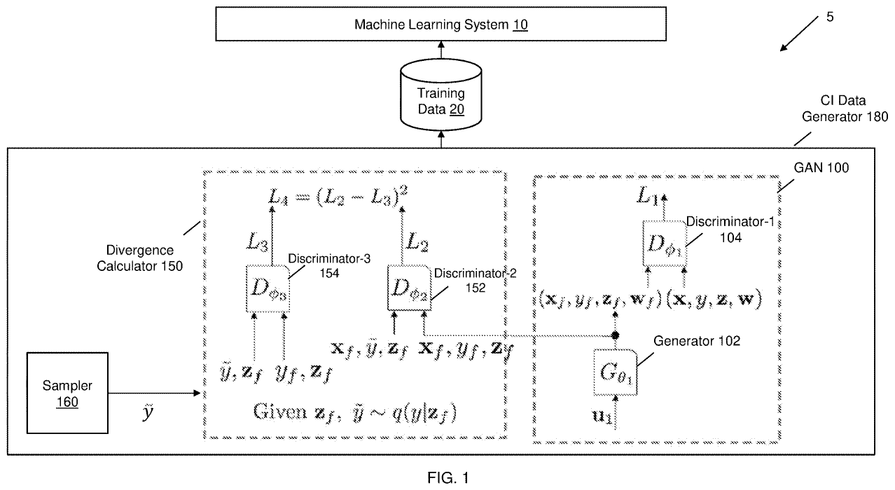

FIG. 1 depicts a system 5 for generating conditionally independent training data for a machine learning system according to one or more embodiments of the present invention. The system 5 depicts a machine learning system 10 that is to be trained using training data 20. The machine learning system 10 can be based on supervised, unsupervised, reinforcement, semi-supervised learning, or be any other type of machine learning system. Once trained, the machine learning system 10 can be used to infer, i.e., make predictions/decisions/detections, based on real-time data. The machine learning system 10 can be a computing system that includes one or more computers. In some embodiments, the machine learning system 10 is a cloud computing platform. The machine learning system 10 can be trained and subsequently used to automatically detect features in data, such as images, video, text, health data, financial data, chemical/protein data, industrial data, weather data, traffic data, or any other type of data or a combination thereof, that is to be analyzed.

The machine learning system 10, automatically analyzes the input data to provide a prediction and/or detection. The detection can include detecting one or more features in the input data. The prediction can be based on the detection in some cases. The prediction represents a possible (most likely) event based on the input data, which may require the machine learning system to perform one or more actions. In some embodiments of the present invention, the machine learning system 10 performs or causes the performance of such action(s), such as controlling an apparatus (e.g., vehicle, industrial robot/machine), providing user feedback (e.g., notification via an electronic device), or any other such action based on the prediction or detection.

The training data 20 is data stored in digital/electronic form using a memory device, which can include one or more storage disks. The training data 20 can include data samples that are used by the machine learning system to “learn.” In some embodiments of the present invention, the training data 20 can include “labels” that provide predefined target attributes (values) that can be used by the machine learning system 10 during training. The training data is generated using a GAN (generative adversarial network) 100, which includes two separate neural networks—a generator network 102 and a discriminator network 104. The generator network 102 (generally referred to in the art as a generator) is implemented by a first neural network, and the discriminator network 104 (generally referred to in the art as a discriminator) is implemented by a second neural network. The generator 102 is trained to take, as input, a random variable, u₁, with the distribution p and map the random variable to generate an output (x_{f}, y_{f}, z_{f}). The discriminator 104 is trained to compute a loss L₁ by comparing the generated output with values (x, y, z) from the distribution p.

In existing techniques, if L₁ is below a predetermined threshold, i.e., the discriminator 104 cannot distinguish the data generated by the generator 102 from a value from the distribution p with at least the predetermined threshold, the generated value is used as part of the training data 20. However, as noted earlier, such existing techniques do not account for a bias in the generated data that can be caused by “fairness” (or the lack thereof). It should be noted that fairness is one type of constraint that can be imposed using conditional independence (CI) criteria. However, CI can have additional and/or different implications in other embodiments. As noted earlier, fairness criteria can be based on equalized odds and/or conditional statistical parity. As is described herein, embodiments of the present invention can handle multiple admissible variables without the exponential dependence on dimension entailed by stratification.

To overcome or reduce the bias in the generated training data 20, embodiments of the present invention enforce conditional independence of X and Y given Z, which is expressed as X [symbol] Y|Z. It is noted that CI can have more or different applications than reducing bias or imposing fairness alone. It should be noted that P and other probability distributions used herein are continuous with respect to a measure v and that their Radon-Nikodym derivatives exist, e.g.,

$$\frac{dP}{dv} = p .$$

In particular, v can be the Lebesgue measure over [symbol] ^{d}ₓ× [symbol] ^{d}_{y}× [symbol] ^{d}_{z}, and p is, therefore, a density function. Here, X⊆ [symbol] ^{d}ₓ, y ⊆ [symbol] ^{d}_{y}, z⊆ [symbol] ^{d}_{z}. The same development holds for discrete distributions, with p representing a probability mass function (and v the counting measure).

A divergence D (P, Q) between probability distributions P and Q is usually understood to be a non-negative function D (P, Q)≥0 for all P, Q such that D (P, Q)=0 if and only if P=Q. In some embodiments, D is a function of the corresponding Radon-Nikodym derivatives or densities, i.e., D(p, q) with

$$q = \frac{dQ}{dv} .$$

Embodiments of the invention herein use a characterization of CI that involves divergences between the given distribution P of (X, Y, Z) and a distribution Q of (X, \tilde{Y}, Z), where the joint distribution of (X, Z) is the same as in P while \tilde{Y} ∈ [symbol] follows a conditional distribution Q_{\tilde{Y}|Z} independent of X, with conditional density function q_{\tilde{Y}|Z}. Thus, the marginal density of Q with respect to (\tilde{Y}, Z) is q_{\tilde{Y}|Z}=pzq_{\tilde{Y}|Z}, and the joint density is q=q_{X, \tilde{Y}, Z}=p_{X, Z}q_{\tilde{Y}|Z}. The choice of q_{\tilde{Y}|Z} is flexible and is discussed herein. In some embodiments, q_{\tilde{Y}|Z} is used as a notation to denote the conditional density of \tilde{Y} for a fixed z.

For the characterization of CI, a condition of strict convexity is presumed, i.e., D(P, Q) is a strictly convex function of either p or q. Further, for the characterization of CI, separability is also presumed. Suppose that p and q are joint densities over X× [symbol] with the same marginal density with respect to X, i.e., p=p_{X}p_{Y|X} and q=p_{X}q_{Y|X}. Then D(p, q)= [symbol] _{x˜P}_{ₓ} [D(p_{Y|x}, q_{Y|x})] is the expectation of the divergence between conditional distributions of Y.

It can be mathematically proved that if P_{X, Y, Z} and Q_{X, \tilde{Y}, Z} are the joint distributions of (X, Y, Z) and (X, \tilde{Y}, Z) specified above. If divergence D(p, q) is strictly convex in p and separable, then:

D(p_{X,Y,Z},q_{X,\tilde{Y},Z})=D(p_{Y,Z},q_{\tilde{Y},Z})⇔X [symbol] Y|Z

Further, if D(p, q) is strictly convex in q instead of p (as in the case above), then the same result is obtained by switching the arguments of the divergence. In other words, if D(p, q) is strictly convex in q and separable, then:

D(q_{X,\tilde{Y},Z},p_{X,Y,Z})=D(q_{\tilde{Y},Z},p_{Y,Z})⇔X [symbol] Y|Z

A dependent case and a measure of dependence are considered further. For example, if X and Y are dependent conditioned on Z. Per above discussion, it is implied that D (p_{X, Y, Z}, q_{X, \tilde{Y}, Z})≠D(p_{Y, Z}, q_{\tilde{Y}, Z}), and in fact, DD (p_{X, Y, Z}, q_{X, \tilde{Y}, Z})>D(p_{Y, Z}, q_{\tilde{Y}, Z}) because the difference between the divergences is non-negative, specifically as the expectation of a non-negative function:

ξ(z)= [symbol] _{x˜P}_{_{x|z}}[D(p_{Y|x,z},q_{\tilde{Y}|z})]−D( [symbol] _{x˜P}_{_{x|z}}[P_{Y|x,z}],q_{\tilde{Y}|z}). (1)

The magnitude of this difference D(p_{X, Y, Z}, q_{X, \tilde{Y}, Z})−D(p_{Y, Z}, q_{\tilde{Y}, Z}) is interpreted by one or more embodiments of the present invention as a measure of conditional dependence of X and Y.

In some embodiments of the present invention, taking this interpretation a step further, the function ξ(z) is considered as a measure of the dependence of X and Y conditioned on a particular Z=z. Examination of equation (1) shows that ξ(z) is the “slack” used in Jensen's inequality, i.e., the difference between the expectation of a convex function of p_{Y|x, z} and the same convex function evaluated at the expected value of p_{Y|x, z}, which is p_{Y|z}. Qualitatively, the more that p_{Y|x, z} varies with (i.e., depends on) x, the greater the slack ξ(z) is expected to be. If p_{Y|x, z} does not vary with x, it is very likely that ξ(z)=0.

In some embodiments, ξ(z) is related to a measure of variation with x based on [symbol] ₂ distance between p_{Y|x, z} and p_{Y|z}.

Further yet, if D(p, q) is differentiable and strongly convex in p with parameter m, and if p_{Y|z}, p_{Y|x, z} for all x such that p_{X|z} (x|z)>0, and ∇ₚD(p, q_{\tilde{Y}|z})|ₚ₌ₚ_{_{Y|z}} all belong to the space of square-integrable functions [symbol] ₂( [symbol] ). Then

$$ξ ( z ) \geq \frac{m}{2} {𝔼}_{x \sim {P}_{X \vert z}} [ {‖ {p}_{Y \vert x , z} - {p}_{Y \vert z} ‖}_{{ℒ}_{2}}^{2} ] .$$

The conditions for convexity and separability can be satisfied by various types of divergence calculations such as f-divergence (with/without conditioning), Kullback-Liebler (KL) divergence, Jensen-Shannon divergence, Bregman divergence, etc. f-divergence between two distributions P and Q can be expressed as:

$${D}_{f} ( p , q ) = {𝔼}_{Q} [ f ( \frac{p ( X )}{q ( X )} ) ] .$$

Here, p(x) and q(x) are densities of distributions P and Q, with P being continuous with respect to Q, and a convex function ƒ: [symbol] ₊ [symbol] [symbol] such that ƒ(1)=0.

In the case of KL divergence, KL(p∥q)= [symbol] _{P} [log(p(X)/q(X))]. Hence the CI conditions stated above can be used because of the known condition of conditional mutual information being zero in this case. Accordingly, some embodiments of the present invention use the KL divergence.

In the case of Bregman divergences, a function F defines the calculation, where F is a strictly convex and differentiable function mapping probability distributions to the reals. The calculation of divergence is expressed as:

D_{F}(p,q)=F(p)−F(q)− [symbol] ∇F(q),p−q [symbol] . (4)

Here [symbol] ; [symbol] denotes an inner product. Bregman divergences thus satisfy the convexity condition by virtue of (4) and the strict convexity of F. Besides KL divergence (and its generalizations), a Bregman divergence that also satisfies separability is Itakura-Saito distance, due to the fact that it depends on (p, q) only through their ratio, similar to f-divergences.

In some embodiments of the present invention, Jensen-Shannon (JS) divergence is used because it forms the basis for the architecture in Section 3. We use the following definition of JS divergence between distributions P and Q with densities p and q, respectively:

$$J S ( p ‖ q ) = \frac{1}{2} K L ( p ‖ \frac{p + q}{2} ) + \frac{1}{2} K L ( q ‖ \frac{p + q}{2} ) . \qquad ( 3 )$$

The JS divergence is also a f-divergence with

$$f ( t ) = \frac{t}{2} log ( \frac{2 t}{1 + t} ) + \frac{1}{2} log ( \frac{2}{1 + t} ) .$$

JS divergence satisfies both conditions of convexity and separability because fⁿ(t)=1/(2t(1+t))>0 for t>0.

It should be noted that the further description uses JS divergence to describe one or more embodiments of the present invention with respect to the drawings. However, it is understood that other types of divergence calculations can be used instead without affecting the novelty of the technical features described herein.

Referring again to FIG. 1, the depicted system 5 facilitates generating the training data 20 in a conditionally independent manner described herein. In other words, the system 5 provides technical solutions to address the technical challenge of the problem of generating data from a distribution that satisfies the desired CI statement while remaining close to a given data distribution (input). The notation used henceforth includes X, Y, Z, W as random variables that are distributed according to the given distribution with density Pₛ(x, y, z, w). The goal is to generate samples (x_{f}, y_{f}, z_{f}, w_{f})ᵢ from the same domain [symbol] × [symbol] × [symbol] and following a distribution p(x_{f}, y_{f}, z_{f}, w_{f}) that is close to the input distribution pₛ (x, y, z, w) in divergence, while ensuring that X_{f} is conditionally independent of Y_{f} given Z_{f}. As noted earlier, JS divergence is used in embodiments described herein. The optimization can be stated as

minJS(p(x_{f},y_{f},z_{f},w_{f})∥Pₛ(x,y,z,w))s.t.X_{f} [symbol] Y_{f}|Z_{f}. (5)

The system 5 includes a sampler 160 that provides \tilde{Y}˜q(\tilde{y}|z_{f}) such that p(y_{f}|z_{f}) is positive only where q(y_{f}|z_{f})>0 a.s. This ensures that the joint densities p(x_{f}, y_{f}, z_{f}) and q(x_{f}, \tilde{y}_{f}, z_{f})=p(x_{f}, z_{f})q(\tilde{y}|z_{f}) satisfy the absolute continuity condition described herein, which, in turn, ensures the conditional independence described herein.

The output of the sampler 160 is provided to a divergence calculator 150, which enforces CI and fairness. The divergence calculator 150, in some embodiments of the present invention, use the JS divergence to determine a dependence measure based on equation (5) as follows:

minJS(p(x_{f},y_{f},z_{f},w_{f})∥Pₛ(x,y,z,w))s.t.JS(p(x_{f},y_{f},z_{f})∥q(x_{f},\tilde{y},z_{f}))−JS(p(y_{f},z_{f})∥q(\tilde{y},z_{f}))≤δ. (6)

If w=0, then equation (5) can be addressed by generating y_{f} following pₛ(y|z_{f}). However, conditional generation can become difficult at high dimensions. When w is non-empty, an additional trade-off has to be made between CI constraint imposition and closeness between p(x_{f}, y_{f}, z_{f}, w_{f}) and pₛ(x, y, z, w). For example, if the generated data is used to learn a predictor for y_{f}, accuracy cannot be disregarded by ignoring w to satisfy conditional independence among y, x, and z.

The divergence calculator 150 facilitates system 5 to generate samples from a distribution p that aims to solve equation (6). The divergence calculator 150 includes two discriminators: discriminator-2 (D_{Ø2}) 152 and discriminator-3 (D_{Ø3}) 154.

The system 5, accordingly includes three discriminators, D_{Ø4}104, D_{Ø2}152, and D_{Ø3}154. The system 5 further includes the generator G_{θ1} 102. The generator G_{θ1} 102 and the discriminator D_{Ø1} 104 constitute the GAN 100, which brings the generated distribution closer to the original one.

The divergence calculator 150, using D_{Ø2} 152, and D_{Ø3} 154, compute tight variational lower bounds L₂ and L₃ on the two JS divergences in the constraint in equation (6). Loss L₄ then causes the squared difference (L₂−L₃)² to be small. It is understood that other functions of the difference are possible in other embodiments of the present invention.

The loss functions of the three discriminators are GAN losses that approximate the JS divergences between the distributions whose samples are given as input:

$${L}_{1} = {𝔼}_{{u}_{1}} [ log ( 1 - {D}_{{ϕ}_{1}} ( {G}_{{θ}_{1}} ( {u}_{1} ) ) ) ] + {𝔼}_{( x , y , z ) \sim {p}_{s} ( x , y , z , w )} [ log {D}_{{ϕ}_{1}} ( x , y , z , w ) ] \qquad ( 7 )$$

$${L}_{2} = {𝔼}_{{u}_{1}} [ log ( 1 - {D}_{{ϕ}_{2}} ( {G}_{{θ}_{1}} ( {u}_{1} ) ) ) ] + {𝔼}_{( {x}_{f} , \tilde{y} , {z}_{f} )} [ log {D}_{{ϕ}_{2}} ( {x}_{f} , \tilde{y} , {z}_{f} ) ]$$

$${L}_{3} = {𝔼}_{{y}_{f} , {z}_{f}} [ log ( 1 - {D}_{{ϕ}_{3}} ( {y}_{f} , {z}_{f} ) ) ] + {𝔼}_{( \tilde{y} , {z}_{f} )} [ log {D}_{{ϕ}_{3}} ( \tilde{y} , {z}_{f} ) ] .$$

Here,

$${D}_{ω} ( x ) = \frac{1}{1 + {e}^{- {V}_{w} ( x )}}$$

is the sigmoid function acting on the log it output V_{W} (x) of a deep neural network parameterized by co.

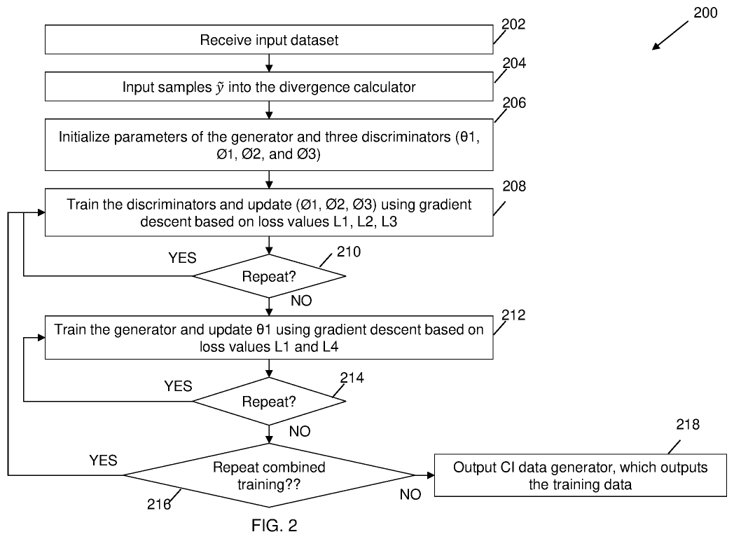

FIG. 2 depicts a flowchart of a method for training the neural networks of the system 5 for generating training data conditional independence and fairness according to one or more embodiments of the present invention. The method 200 is depicted in the form of an algorithm in table 1.

The method 200 includes receiving the input dataset, at block 202. The sampler 160 generates and provides \tilde{Y}˜q(\tilde{y}|z_{f}) to the divergence calculator 150, at block 204. The neural networks in the system 5 are initialized at block 206. The initialization includes setting the one or more parameters of the neural networks. Herein we refer to the one or more parameters of the generator 102 as θ1, of D_{Ø1} 104 as Ø 1, of D_{Ø2} 152 as Ø2, and of D_{Ø3} 154 as Ø3. The initialization of the parameters can include setting random values to the parameters in one or more embodiments of the present invention. Default values can be used in other embodiments of the present invention.

The discriminators 104, 152, 154, are trained, at block 208. Training the discriminators 104, 152, 154 includes updating the corresponding parameters until the output of the discriminators 104, 152, 154 is within a predetermined threshold of ground truth. The parameters can be updated using gradient descent/ascent in one or more embodiments of the present invention. For example, gradient descent is used to minimize−L₁, −L₂ and −L₃; or in other examples a gradient ascent is used to maximize L1, L2, and L3. Keeping θ1 fixed, the three discriminators 104, 152, 154 maximize their corresponding losses L1, L2, L3 with respect to their parameters Ø1, Ø2 and Ø3, thus approximating the JS divergences between the input distributions to the discriminators 104, 152, 154. Here, θ1 can be fixed using predetermined values.

TABLE 1
Conditionally Independent Data Generation

| | |
|---|---|
| 1: | Input: Dataset: Dₛ ~ pₛ(x,y,z); Iterations: T₁,T₂,E; Step- |
| | sizes: η₁, η₂; Sampler: Given z_{f} samples \tilde{y} ~ q(\tilde{y}\|z_{f}). |
| 2: | Initialize: Set parameters ϕ₁,ϕ₂,ϕ₃,θ₁ randomly, and iteration |
| | counter e = 1. |
| 3: | for e = 1, . . . , E do |
| 4: | for t₁ = 1, . . . , T₁ do |
| 5: | (ϕ₁,ϕ₂,ϕ₃) ← GRADIENT DESCENT(−L₃ − L₂ − |
| | L₁, η₁, (ϕ₁,ϕ₂,ϕ₃)) [symbol] Train Discriminators |
| 6: | for t₂ = 1, . . . , T₂ do |
| 7: | θ₁ ← GRADIENT DESCENT(L₁ + γL₄, η₂, θ₁) [symbol] Train |
| | Generator |
| 8: | Output: Generator G_{θ}_{₁}. |

The discriminators 104, 152, 154 are trained multiple times in one or more embodiments of the present invention, based on a predetermined number of trainings to be performed, at block 210.

Once the discriminators 104, 152, 154 are trained (or the number of iterations is completed), the generator 102 is trained, at block 212. The parameters Ø1, Ø2 and Ø3, resulting from the training of the discriminators 104, 152, 154 are maintained fixed while training the generator 102. The generator is trained to optimize the combination of two losses, one that enforces similarity between the given and generated distributions (L₁), and one that ensures the desired CI (L₄). The generator objective is

min γL₄+L₁. (8)

Here, γ is used as a trade-off parameter. The generator 102 minimizes only the (squared) difference between losses (L₂-L₃)², and not L₂ and L₃ themselves.

The generator 102 is trained in this manner at least a predetermined number of times, at block 214. Further, the combined training, i.e., training of the discriminators 104, 152, 154 (block 208) and training of the generator 102 (block 212), is repeated at least a predetermined number of times, at block 216.

Once the predetermined number of iterations of the training are completed, the CI data generator 180 is output, at block 218. The CI data generator 180 can generate one or more values for the training data 20 to train the machine learning system 10.

In one or more embodiments of the present invention, if [symbol] , the domain of Y, Y_{f}, and \tilde{Y}, is bounded or discrete with finite cardinality, then the sampling distribution q(\tilde{y}|z_{f}) is chosen to be uniform over the support. This ensures that q(\tilde{y}|z_{f}) covers the support of p(y|z_{f}) completely. It also resolves any support issues in estimating JS divergence by discriminators 152, 154, so that losses L₂ and L₃ do not diverge to infinity even if discriminator training is run for longer. In fairness applications, Y can be taken to be a scalar outcome variable in one or more embodiments of the present invention, i.e., d_{y}=1. In classification settings, it has a finite cardinality. Hence, in one or more embodiments of the present invention, a uniform sampling is used. In other embodiments, a random sampling can also be used.

In one or more embodiments of the present invention, the architecture of the CI data generator 180 can be configured to apply fairness in machine learning, and specifically to enforcing two fairness measures that involve conditioning. The first is conditional statistical parity (CSP) to make outcomes (i.e., training data 20) independent of protected attributes conditioned on admissible variables A, i.e. Y_{f} [symbol] S|A. The importance of CSP is known in cases such as during admission selection, where the bias in admissions (Y_{f}) against one set of applicants (S is identifying attribute of the set of applicants) changed patterns when conditioned on departments (A). In the CSP case, the advantage of the CI generation method 200 described herein is that it handles multiple admissible variables (e.g., continuous) while avoiding enumeration of all their values. This is a significant reduction in computer resources and a technical improvement in computing technology, particularly generating training data 20 for a machine learning system 10.

The second fairness criterion is equalized odds (EO), a well-known measure used in fair binary classification. It requires equal rates of false positives and false negatives between groups defined by protected attributes S. Denoting the predicted and true labels by Y_{f} and Y, this corresponds to Y_{f} [symbol] S|Y.

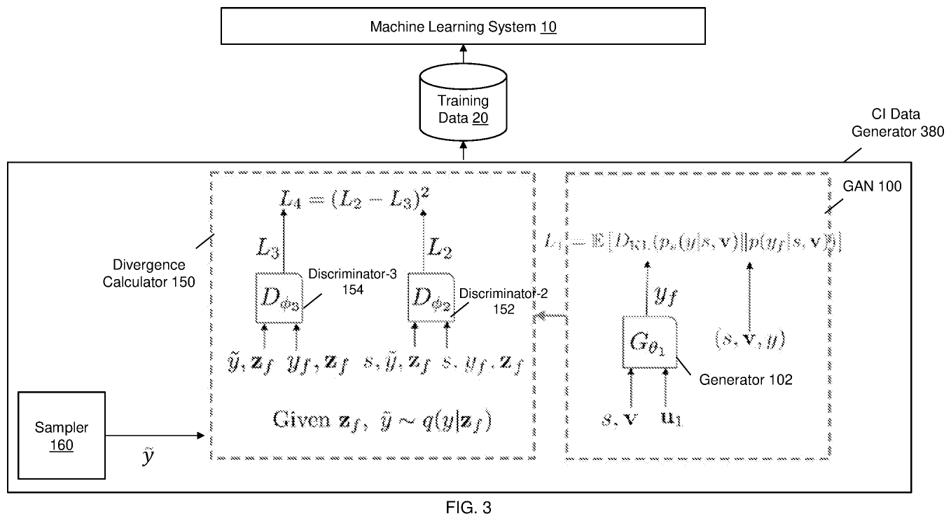

FIG. 3 depicts an architecture of a CI data generator 380 to promote CSP and EO according to one or more embodiments of the present invention. The sensitive attributes S play the role of X_{f}. In the CSP case, the conditioning variable Z_{f}=A, represents the admissible variables, whereas in the EO case, Z_{f} maps to Y, the true label. The symbol v represents all predictor variables other than the sensitive attributes, including admissible variables.

The differences between the CI data generator 380 and the CI data generator 180 (FIG. 1) include that only the binary Y_{f} is generated while X_{f}=S and Z_{f}=A or Z_{f}=Y come from the original data. As a consequence, the generator 102 reduces to a classifier that takes the feature set (S, v) and outputs a predicted label Y_{f} such that the cross-entropy loss (L₁) between the ground truth and predicted label distributions is small. This cross-entropy loss takes on the role of discriminator 104 (D_{Ø1}) from FIG. 1. The other components, particularly the divergence calculator 150, stay the same as FIG. 1.

Various experiments have been performed by the inventors to test the CI and fairness of the data generated using one or more embodiments of the present invention using several datasets. In some examples, a target variable was whether a person's annual income exceeds a threshold, such as 50,000 USD. One or more attributes from the datasets were used as the protected attributes in the example. For the CSP experiments, years of education and hours worked per week were used as admissible attributes because these are well-accepted as legitimate determinants of income. Using the dataset's fixed train/test split results were reported on the test set. Additionally, in some examples, 30% of the training samples were held out as the validation set. The mean and standard error over 25 runs for the metrics were used.

For CSP, in the experiment, with at least one protected attribute, a maximum conditional statistical disparity (MCSD) was evaluated by first computing the difference between predicted positive rates for different categories (based on the protected attribute), conditioned on each value of the admissible variable and then taking the maximum absolute difference. The technical solutions for CI data described herein with γ=0 in (8) achieved an accuracy of (82.6±0.2) % in the experimental setup. The accuracy and MCSD values change as the value of γ is changed. In further experiments, with years of education as the admissible variable, the baseline MCSD for γ=0 was (38.2±1.4)%, whereas, with both education and work hours per week as admissible variables the baseline, MCSD is (37.5±1.1)% for education (averaging out hours/week) was (34.8±1.9)% for hours/week (averaging out education). Increasing γ reduces MCSD without a substantial reduction in the accuracy.

For EO, generated data using one or more embodiments of the present invention was tested using adversarial debiasing (AD) algorithm as a point of reference, which developed specifically for fairness. Adherence to EO is measured by the average absolute equalized odds difference (EOD), which is the average of the absolute differences in false-positive rate (FPR) and negative rate (FNR) between two protected groups. In the experiments performed, the CI techniques described herein, with γ=0 in (8), achieved an accuracy of (82.6±0.2) % and an EOD of (6.0±0.5) %. AD, in the corresponding situation, achieves (85.2±0.1) % accuracy and (4.2±0.2) % EOD, considering irreconcilable differences in the experimental setups for AD and one or more embodiments of the present invention. For CI, increasing γ enforces EO more strictly, while accuracy decreases modestly. For AD, however, the EOD decreases only slightly before results deteriorate, with a large decrease in accuracy and unexpected increase in EOD.

Experiments were also performed to consider multiple protected attributes together. While AD can, in principle, be applied to this setting by encoding the protected attributes (e.g., 2 protected attributes as a single 4-category variable), it requires changing the discriminator loss to multiclass, which did not provide reasonable results during the experiments. In contrast, CI techniques described herein naturally handle multiple protected attributes. For γ=0 in (8), the EOD between a first protected attribute is (4.8±0.4) % after averaging out a second protected attribute, and (6.2±0.4) % between the second protected attribute after averaging out the first protected attribute. For y=10, these numbers decrease to (2.8±0.2) % and (4.7±0.7) %, respectively, thus improving EO with respect to both protected attributes, while accuracy is unchanged.

Embodiments of the present invention address the problem of enforcing conditional independence (CI) during the generation of data, particularly that is being automatically generated. Underpinning the technical solutions described herein is a flexible characterization of CI in the form of an identity that holds for a wide class of divergences. This identity forms the basis for a differentiable GAN-based architecture for generating data to balance adherence to a desired CI with proximity to a given data distribution. Experimental setup of the technical solutions has demonstrated applications to enforcing the fairness criteria of equalized odds and conditional statistical parity.

The CI-enforcing GAN architecture described herein exploits the Jensen-Shannon version of the divergence identity, and fairness is only one application of conditionally independent data generation. However, it is understood that other types of divergence identity can be used by the divergence calculator (150) described herein. Further, different fairness criteria can be used to generate the training data depending on the type of data, type of machine learning system, or any other such parameters.

Embodiments of the present invention accordingly provide improvements to computing technology and further provide practical application to a technical challenge in the various fields where conditionally independent data is used for training machine learning systems. As described herein, generating such conditionally independent data as a mental process is not practical, particularly with a large dataset that is typically used for training machine learning systems. Further, the data that is generated is represented in a digital form, and a computer is an integral part used to generate such conditionally independent data. Embodiments of the present invention accordingly facilitate improvements to the computing technology that is used to generate conditionally independent data, and in turn improving computing technology for machine learning systems.

It is to be understood that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

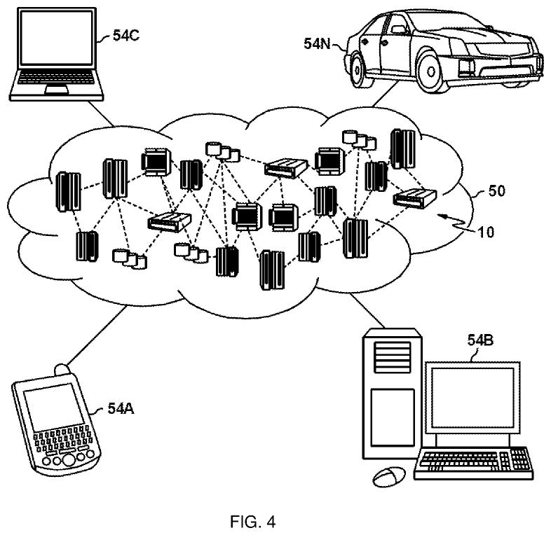

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

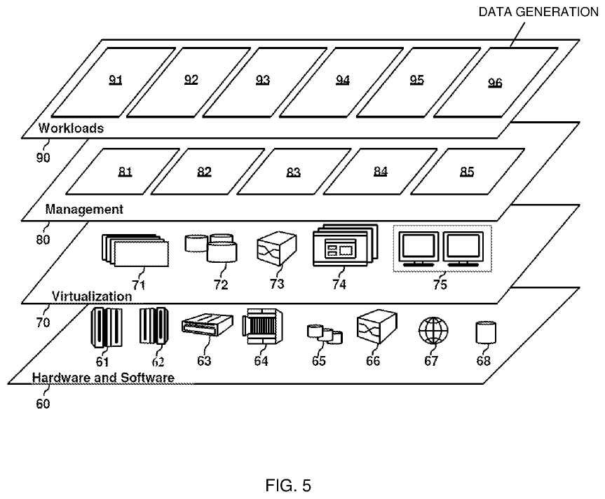

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and training data generation 96.

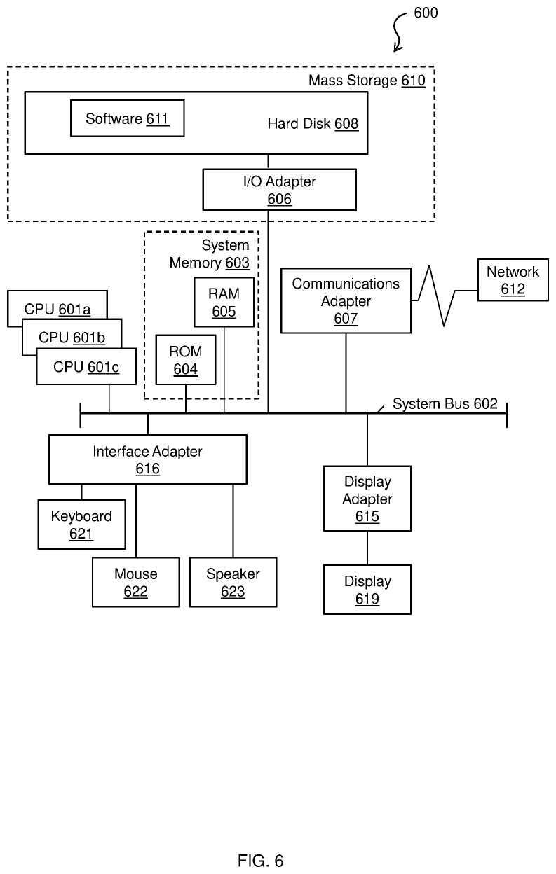

Turning now to FIG. 6, a computer system 600 is generally shown in accordance with an embodiment. The computer system 600 can be used to implement one or more neural networks, such as the generator 102, and/or the discriminators 104, 152, 154, or any other components in one or more embodiments of the present invention. The computer can also be used to implement the machine learning system 10. The computer system 600 can be an electronic, computer framework comprising and/or employing any number and combination of computing devices and networks utilizing various communication technologies, as described herein. The computer system 600 can be easily scalable, extensible, and modular, with the ability to change to different services or reconfigure some features independently of others. The computer system 600 may be, for example, a server, desktop computer, laptop computer, tablet computer, or smartphone. In some examples, computer system 600 may be a cloud computing node. Computer system 600 may be described in the general context of computer system executable instructions, such as program modules, being executed by a computer system. Generally, program modules may include routines, programs, objects, components, logic, data structures, and so on that perform particular tasks or implement particular abstract data types. Computer system 600 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, the computer system 600 has one or more central processing units (CPU(s)) 601a, 601b, 601c, etc. (collectively or generically referred to as processor(s) 601). The processors 601 can be a single-core processor, multi-core processor, computing cluster, or any number of other configurations. The processors 601, also referred to as processing circuits, are coupled via a system bus 602 to a system memory 603 and various other components. The system memory 603 can include a read only memory (ROM) 604 and a random access memory (RAM) 605. The ROM 604 is coupled to the system bus 602 and may include a basic input/output system (BIOS), which controls certain basic functions of the computer system 600. The RAM is read-write memory coupled to the system bus 602 for use by the processors 601. The system memory 603 provides temporary memory space for operations of said instructions during operation. The system memory 603 can include random access memory (RAM), read only memory, flash memory, or any other suitable memory systems.

The computer system 600 comprises an input/output (I/O) adapter 606 and a communications adapter 607 coupled to the system bus 602. The I/O adapter 606 may be a small computer system interface (SCSI) adapter that communicates with a hard disk 608 and/or any other similar component. The I/O adapter 606 and the hard disk 608 are collectively referred to herein as a mass storage 610.

Software 611 for execution on the computer system 600 may be stored in the mass storage 610. The mass storage 610 is an example of a tangible storage medium readable by the processors 601, where the software 611 is stored as instructions for execution by the processors 601 to cause the computer system 600 to operate, such as is described herein below with respect to the various Figures. Examples of computer program product and the execution of such instruction is discussed herein in more detail. The communications adapter 607 interconnects the system bus 602 with a network 612, which may be an outside network, enabling the computer system 600 to communicate with other such systems. In one embodiment, a portion of the system memory 603 and the mass storage 610 collectively store an operating system, which may be any appropriate operating system, such as the z/OS or AIX operating system from IBM Corporation, to coordinate the functions of the various components shown in FIG. 6.

Additional input/output devices are shown as connected to the system bus 602 via a display adapter 615 and an interface adapter 616 and. In one embodiment, the adapters 606, 607, 615, and 616 may be connected to one or more I/O buses that are connected to the system bus 602 via an intermediate bus bridge (not shown). A display 619 (e.g., a screen or a display monitor) is connected to the system bus 602 by a display adapter 615, which may include a graphics controller to improve the performance of graphics intensive applications and a video controller. A keyboard 621, a mouse 622, a speaker 623, etc. can be interconnected to the system bus 602 via the interface adapter 616, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 6, the computer system 600 includes processing capability in the form of the processors 601, and, storage capability including the system memory 603 and the mass storage 610, input means such as the keyboard 621 and the mouse 622, and output capability including the speaker 623 and the display 619.

In some embodiments, the communications adapter 607 can transmit data using any suitable interface or protocol, such as the internet small computer system interface, among others. The network 612 may be a cellular network, a radio network, a wide area network (WAN), a local area network (LAN), or the Internet, among others. An external computing device may connect to the computer system 600 through the network 612. In some examples, an external computing device may be an external webserver or a cloud computing node.

It is to be understood that the block diagram of FIG. 6 is not intended to indicate that the computer system 600 is to include all of the components shown in FIG. 6. Rather, the computer system 600 can include any appropriate fewer or additional components not illustrated in FIG. 6 (e.g., additional memory components, embedded controllers, modules, additional network interfaces, etc.). Further, the embodiments described herein with respect to computer system 600 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

What is claimed is:

1. A computer-implemented method for training a machine learning system using conditionally independent training data, the computer-implemented method comprising:
receiving an input dataset (p (x, y, z));
generating, using a generative adversarial network, based on the input dataset, a training data (pₛ (x_{f}, y_{f}, z_{f})), the generative adversarial network comprises a generator and a first discriminator, wherein generating the training data comprises:
generating, by the generator, the values (x_{f}, y_{f}, z_{f}) for the training data using machine learning;
determining, by the first discriminator, a first loss (L₁) based on a comparison between the values for the training data (x_{f}, y_{f}, z_{f}) and values from the input dataset (x, y, z);
modifying, using a divergence calculator, the training data based on a dependence measure (γ), the divergence calculator comprises a second discriminator, and a third discriminator, wherein modifying the training data comprises:
receiving, from a sampler, a reference value (\tilde{y}) from the input dataset;
computing, by the second discriminator, a second loss (L₂) based on a comparison of a first set of values (x_{f}, y_{f}, z_{f}) from the generator and a second set of values (x_{f}, \tilde{y}, z_{f}) comprising a combination of the training data from the generator and the reference value;
computing, by the third discriminator, a third loss (L₃) based on a comparison of (y_{f}, z_{f}) and (\tilde{y}, z_{f}); and
computing a fourth loss (L₄) based on the second loss and the third loss;
outputting the training data from the generator in response to the first loss and the fourth loss satisfying a predetermined condition, the training data being conditionally independent, the training data being used to train a machine learning system.

2. The computer-implemented method of claim 1, wherein the generator, the first discriminator, the second discriminator, and the third discriminator comprise neural networks.

3. The computer-implemented method of claim 2, wherein the generator, the first discriminator, the second discriminator, and the third discriminator are trained in combination.

4. The computer-implemented method of claim 3, wherein training the first discriminator, the second discriminator, and the third discriminator comprises:
initializing parameters θ1, Ø1, Ø2, and Ø3, corresponding to the generator, the first discriminator, the second discriminator, and the third discriminator, respectively; and
training the first discriminator, the second discriminator, and the third discriminator by keeping θ1 fixed, and updating Ø1, Ø2, Ø3 using gradient ascent to maximize the first loss L₁, the second loss L₂, and the third loss L₃.

5. The computer-implemented method of claim 3, wherein training the generator comprises:
initializing parameters θ1, Ø1, Ø2, and Ø3, corresponding to the generator, the first discriminator, the second discriminator, and the third discriminator, respectively; and
keeping Ø1, Ø2, Ø3 fixed, and updating θ1 using gradient descent to minimize the first loss L₁, and the fourth loss L₄.

6. The computer-implemented method of claim 1, wherein L₄=(L₂−L₃)².

7. The computer-implemented method of claim 6, wherein the training data is generated with enforced fairness using constraints on conditional statistical parity and equalized odds.

8. A computer system for training a machine learning system using conditionally independent training data, the system comprising:
a machine learning system; and
a conditionally independent data generator that is configured to generate training data to train the machine learning system, the conditionally independent data generator comprising:
a generative adversarial network comprising:
a generator neural network that generates a training data (pₛ(x_{f}, y_{f}, z_{f})) based on an input dataset (p(x, y, z)); and
a first discriminator neural network that computes a first loss (L₁) based on a comparison between the values for the training data (x_{f}, y_{f}, z_{f}) and values from the input dataset (x, y, z); and
a divergence calculator comprising:
a second discriminator neural network that computes a second loss (L₂) based on a comparison of a first set of values (x_{f}, y_{f}, z_{f}) from the generator and a second set of values (x_{f}, \tilde{y}, z_{f}) comprising a combination of the training data from the generator and a reference value (\tilde{y}); and
a third discriminator neural network that computes a third loss (L₃) based on a comparison of (y_{f}, z_{f}) and (\tilde{y}, z_{f});
wherein the divergence calculator computes a fourth loss (L₄) based on the second loss and the third loss; and
wherein the training data from the generator is output as conditionally independent training data to be used as the training data for the machine learning system in response to the first loss and the fourth loss satisfying a predetermined condition.

9. The computer system of claim 8, wherein the reference value (\tilde{y}) is generated by a uniform sampler.

10. The computer system of claim 8, wherein the generator neural network, the first discriminator neural network, the second discriminator neural network, and the third discriminator neural network are trained in combination.

11. The computer system of claim 10, wherein training the first discriminator neural network, the second discriminator neural network, and the third discriminator neural network comprises:
initializing parameters θ1, Ø1, Ø2, and Ø3, corresponding to the generator neural network, the first discriminator neural network, the second discriminator neural network, and the third discriminator neural network, respectively; and
training the first discriminator neural network, the second discriminator neural network, and the third discriminator neural network by keeping θ1 fixed, and updating Ø1, Ø2, Ø3 using gradient ascent to maximize the first loss L₁, the second loss L₂, and the third loss L₃.

12. The computer system of claim 10, wherein training the generator neural network comprises:
initializing parameters θ1, Ø1, Ø2, and Ø3, corresponding to the generator neural network, the first discriminator neural network, the second discriminator neural network, and the third discriminator neural network, respectively; and
keeping Ø1, Ø2, Ø3 fixed, and updating θ1 using gradient descent to minimize the first loss L₁, and the fourth loss L₄.

13. The system of claim 8, wherein L₄=(L₂−L₃)².

14. The system of claim 8, wherein the training data is generated with enforced fairness using constraints on conditional statistical parity and equalized odds.

15. A computer program product comprising a memory device having computer-executable instructions stored thereon, the computer-executable instructions when executed by one or more processing units cause the one or more processing units to perform a method for training a machine learning system using conditionally independent training data, the method comprising:
receiving an input dataset (p (x, y, z));
generating, using a generative adversarial network, based on the input dataset, a training data (pₛ (x_{f}, y_{f}, z_{f})), the generative adversarial network comprises a generator and a first discriminator, wherein generating the training data comprises:
generating, by the generator, the values (x_{f}, y_{f}, z_{f}) for the training data using machine learning;
determining, by the first discriminator, a first loss (L₁) based on a comparison between the values for the training data (x_{f}, y_{f}, z_{f}) and values from the input dataset (x, y, z);
modifying, using a divergence calculator, the training data based on a dependence measure (γ), the divergence calculator comprises a second discriminator, and a third discriminator, wherein modifying the training data comprises:
receiving, from a sampler, a reference value (\tilde{y});
computing, by the second discriminator, a second loss (L₂) based on a comparison of a first set of values (x_{f}, y_{f}, z_{f}) from the generator and a second set of values (x_{f}, \tilde{y}, z_{f}) comprising a combination of the training data from the generator and the reference value;
computing, by the third discriminator, a third loss (L₃) based on a comparison (y_{f}, z_{f}) and (\tilde{y}, z_{f}), wherein y is a reference value; and
computing a fourth loss (L₄) based on the second loss and the third loss;
outputting the training data from the generator in response to the first loss and the fourth loss satisfying a predetermined condition, the training data being conditionally independent, the training data being used to train a machine learning system.

16. The computer program product of claim 15, wherein the generator, the first discriminator, the second discriminator, and the third discriminator are neural networks trained in combination.

17. The computer program product of claim 16, wherein training the first discriminator, the second discriminator, and the third discriminator comprises:
initializing parameters θ1, Ø1, Ø2, and Ø3, corresponding to the generator, the first discriminator, the second discriminator, and the third discriminator, respectively; and
training the first discriminator, the second discriminator, and the third discriminator by keeping θ1 fixed, and updating Ø1, Ø2, Ø3 using gradient ascent to maximize the first loss L₁, the second loss L₂, and the third loss L₃.

18. The computer program product of claim 16, wherein training the generator comprises:
initializing parameters θ1, Ø1, Ø2, and Ø3, corresponding to the generator, the first discriminator, the second discriminator, and the third discriminator, respectively; and
keeping Ø1, Ø2, Ø3 fixed, and updating θ1 using gradient descent to minimize the first loss L₁, and the fourth loss L₄.

19. The computer program product of claim 15, wherein L₄=(L₂−L₃)².

20. The computer program product of claim 15, wherein the training data is generated with enforced fairness using constraints on conditional statistical parity and equalized odds.
